(19) United States
(12) Patent Application Publication
(10) Pub. No.: US 2020/0387478 A1
(43) Pub. Date: Dec. 10, 2020

(54) FILE SYSTEM VIEW OF FILES WITH SYNTHETIC ATTRIBUTES

(71) Applicant: Microsoft Technology Licensing, LLC, Redmond, WA (US)

(72) Inventors: Trevor Joel Harris, Seattle, WA (US); Nathaniel Marvin Myhre, Kirkland, WA (US); Malia Morioka Douglas, Seattle, WA (US); Shikha Devesh Desai, Bellevue, WA (US); Yoon Jin Lee, Woodinville, WA (US); Peter Loren Engrav, Seattle, WA (US)

(21) Appl. No.: 16/434,467

(22) Filed: Jun. 7, 2019

(51) Int. Cl. G06F 16/16; G06F 3/0482

(52) U.S. Cl. CPC G06F 16/168; G06F 3/0482; G06F 16/166

(57) ABSTRACT

Technology is disclosed herein for enhancing a file aggregation service. In an implementation, a set of files associated with a user is identified. For at least a file of the set of files, one or more events that occurred with respect to the file are identified. Based at least on the one or more events, one or more synthetic attributes of the file are generated. The one or more synthetic attributes comprise an attribute that differs relative to existing attributes of the file. A file system view of the set of files is then generated which comprises the one or more synthetic attributes of the file. The file system view of the set of files is displayed to a user.

### TECHNICAL FIELD

Aspects of the disclosure are related to computing hardware and software technology, and in particular to file aggregation services.

### TECHNICAL BACKGROUND

Many software applications and services provide users with the ability to create, store, and access files on a variety of devices and within a variety of storage locations. Such software applications and services have continued to improve the ability of users to originate the file in one storage location, and then share, move, or copy the file to another storage location. Therefore, multiple instances of a file may be created when multiple users are interacting with the file using a variety of devices and applications.

A user may view a list of their existing files on devices or within file hosting services. These file system views show which files are in each location and their respective file names However, current file view systems do not retain data which can be used to provide the user with context about the file, such as the file origin or previous file names While a view of the user's files may allow the user to view existing names and locations of their files, the file information displayed to the user can be confusing and unmeaningful.

### OVERVIEW

Technology is disclosed herein that improves the display of files in a file aggregation service. In an implementation, a set of files associated with a user is identified. For at least a file of the set of files, one or more events that occurred with respect to the file are identified. Based at least on the one or more events, one or more synthetic attributes of the file are generated. The one or more synthetic attributes comprise an attribute that differs relative to existing attributes of the file. A file system view of the set of files is then generated which comprises the one or more synthetic attributes of the file. The file system view of the set of files is displayed to a user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an operational architecture for implementing an enhanced file aggregation service.

FIG. 2 illustrates a file attribute synthesizing process employed in implementations of an enhanced file aggregation service.

FIG. 3 illustrates an operational sequence in an implementation of an enhanced file aggregation service.

FIG. 4 illustrates an alternative operational sequence in an implementation of an enhanced file aggregation service.

FIG. 5 illustrates an alternative operational sequence in an implementation of an enhanced file aggregation service.

FIG. 6 illustrates a user experience in an implementation of an enhanced file aggregation service.

FIG. 7 illustrates a user interface in accordance with enhanced file aggregation service.

FIG. 8 illustrates an alternative user interface in accordance with enhanced file aggregation service.

FIG. 9 illustrates a data structure in an implementation of an enhanced file aggregation service.

FIG. 10 illustrates a computing system suitable for implementing the technology disclosed herein, including any of the architectures, processes, operational scenarios, and operational sequences illustrated in the Figures and discussed below in the Technical Description.

### TECHNICAL DESCRIPTION

Examples of the present disclosure describe systems, methods, and software for enhancing a file aggregation service. In an implementation, a set of files associated with a user is identified. For at least a file of the set of files, one or more events that occurred with respect to the file are identified. Based at least on the one or more events, one or more synthetic attributes of the file are generated. The one or more synthetic attributes comprise an attribute that differs relative to existing attributes of the file. A file system view of the set of files is then generated which comprises the one or more synthetic attributes of the file. The file system view of the set of files is displayed to a user.

A technical effect that may be appreciated from the present discussion is the increased efficiency for a user to view and contextually identify all their files located in a variety of storage locations and stored in a variety of formats. For example, a user may originate a file in one location, and then move or copy the file to another location. Furthermore, the user may rename the file or store several instances of the file using the same or different names The file aggregation service described herein retains personal and historical information associated with the file and may display the file using one more synthesized attributes of the file. Advantageously, this allows a user to view contextual information about the file, which may be different from the current information associated with the file (e.g., previous names of the file, file nicknames and aliases, originating locations of the file, etc.).

Another technical effect that may be appreciated from the present discussion is the ability of a user to view a file journey and how each of the instances of the file are connected to the current instance of the file (e.g., users who have shared or interacted with the document, drafts stored on different devices and in different file hosting services, events which have occurred with respect to the documents, etc.). The file aggregation service described herein also improves the efficiency in generating the file system view since the service may receive updated file metadata from local device storage systems, file hosting systems, other services and applications user to interact with the files, or even the files themselves. This reduces the time and resources which would be required to query each of the file system services for the files information.

Further, examples herein described that the one or more synthetic attributes of the file comprise one or more synthetic names of the file. The file system view of the set of files is then displayed using at least the one or more synthetic names of the file of the set files. In other scenarios, the one or more synthetic attributes of the file comprise one or more identifications of file hosting services associated with the file. In this scenario, the file system view of the set of files is displayed using at least the one or more identifications of file hosting services associated with the file.

In some scenarios, identifying the one or more events that occurred with respect to the file comprises determining that the file has been renamed in a location in which the file is stored. The file system view of the set of files are generated using at least a previous name of the file, wherein the previous name differs from the current name of the file. The file system view of the set of files are then displayed using at least the previous name of the file. In other scenarios, identifying the one or more events that occurred with respect to the file comprises receiving user input indicating an alias of the file. The file system view is then generated and displayed using at least the alias of the file, wherein the alias differs from the actual name of the file.

In some implementations, identifying the one or more events that occurred with respect to the file comprises determining that the file has been moved from a source location of the file to a destination location of the file. In this implementation, the file system view of the set of files are generated and displayed using at least the source location of the file, wherein the source location of the file differs from the destination location of the file. In other implementations, identifying the one or more events that occurred with respect to the file comprises determining that the file has been saved from an email service to file hosting service. The file system view of the set of files is then generated and displayed using at the least the email service from which the file was originally received.

In yet a further example, the file aggregation service generates an expanded file system view of at least the file of the set of files. In this example, the expanded view of the file comprises the existing attributes of the file in addition to the synthetic attributes of the file. A toggle button may be displayed which allows the user to toggle between the file system view and the expanded file system view. In response to a user selection, the expanded file system view of the file is displayed. In many of the examples described herein, the one or more events may be identified by receiving a notification of the one or more events from at least one of a file hosting service, a user application, and a local storage system.

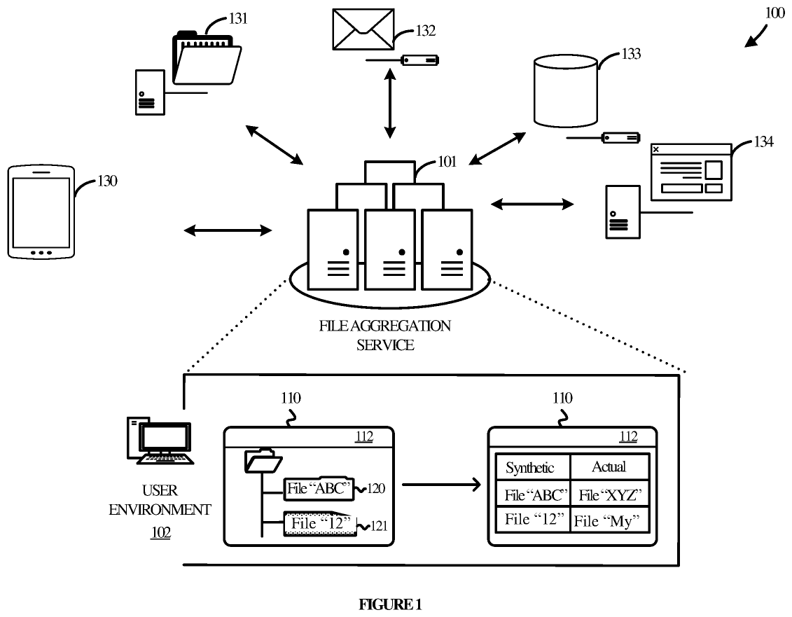

Referring to the drawings, FIG. 1 illustrates an exemplary operational architecture 100 related to processing operations for management of an exemplary enhanced system with which aspects of the present disclosure may be practiced. Operational environment 100 includes file aggregation service 101, file storage locations 130-134, and user environment 102. File aggregation service 101 employs a file attribute synthesizing process 200 in the context of producing file system views to users. User environment 102 displays representative view 110 comprising the synthetized attributes of the files.

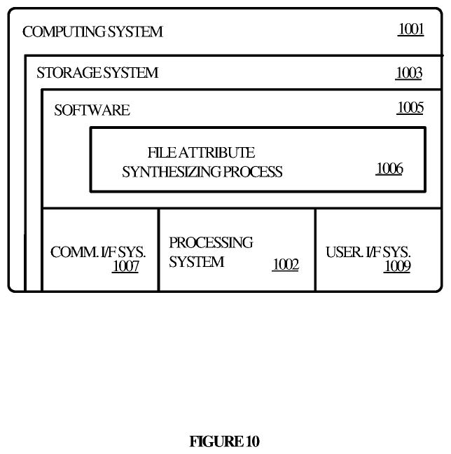

File aggregation service 101 is representative of any device capable of running an application natively or in the context of a web browser, streaming an application, or executing an application in any other manner Examples of file aggregation service 101 include, but are not limited to, personal computers, mobile phones, tablet computers, desktop computers, laptop computers, wearable computing devices, or any other form factor, including any combination of computers or variations thereof. File aggregation service 101 may include various hardware and software elements in a supporting architecture suitable for performing file attribute synthesizing process 200. One such representative architecture is illustrated in FIG. 10 with respect to computing system 1001.

User environment 102 includes representative view 110 that may be produced by file aggregation system 101. Representative view 110 may display file system view 112 of the set of files 120-121. File system view 112 comprises the one or more synthetic attributes of files 120-121. An end user may interface with file aggregation service 101 over user environment 102 using an input instrument such as a stylus, mouse device, keyboard, touch gesture, as well as any other suitable input device.

The user may initiate a command to request file system view 112 be generated. The user may then initiate a command to access or view an enhanced file system view which includes existing attributes of the file in addition to the synthetized attributes of the file. In an enhancement, file aggregation service 101 may further provide the user with a toggle to move between file system view 112 and an enhanced file system view. The user may also initiate a command to add a nickname or alias to a file which differs from the actual name of the file.

Storage locations 130-134 are representative of any device capable of running an application natively or in the context of a web browser, streaming an application, or executing an application in any other manner Examples include, but are not limited to, personal computers, mobile phones, tablet computers, desktop computers, laptop computers, wearable computing devices, or any other form factor, including any combination of computers or variations thereof.

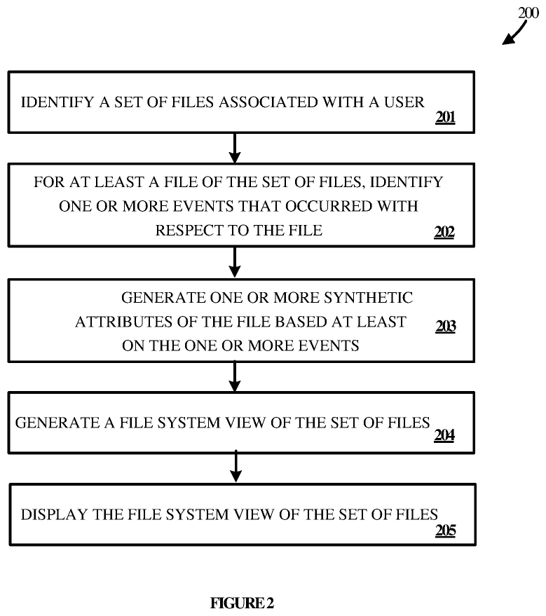

FIG. 2 illustrates a file attribute synthesizing process 200 that may be implemented by file aggregation service 101. The service employs file attribute synthesizing process 200 to enhance the user experience when viewing files in an aggregated file system. File attribute synthesizing process 200 may be implemented in program instructions in the context of any of the modules, components, or other such programming elements of the service. The program instructions direct the underlying computing system(s) to operate as described for file attribute synthesizing process 200, referring parenthetically to the steps in FIG. 2.

To begin, the program instructions direct the computing system(s) to identify a set of files associated with a user (step 201). One or more file storage locations 130-134 may contain files which are associated with the user. For example, a user may store files in a variety of locations, such as an online file storage server and a local file storage on a device. The user may also use a variety of applications and services to interact with a file. For example, a user may create a document using a productivity application. The user may then send the file to another user via an email service. The files may include text documents, spreadsheets, a deck of presentation slides, images, videos, digital sticky notes, etc.

Next, the program instructions direct the computing system(s) to identify one or more events that occurred with respect to at least a file of the set of files (step 202). The event in this step may be identified by receiving file metadata from file storage locations 130-134. The metadata may be, for example, a current name of the file, a source location of file, annotated data associated with the file, a nickname of the file, a set of users which share the file, etc. In some scenarios, the event may be a move or a copy and paste of the file from a source file location to a destination file location. In other scenarios, the event may be a rename of the file in the same file storage location. However, in other scenarios, the event may be a nicknaming of the file in file aggregation service 101 or in one of file storage locations 130-134. The event may further include an email or sharing of the file with another user.

Once the one or more events that occurred with respect to the file have been identified, one or more synthetic attributes of the file are generated based on the one or more events (step 203). The one or more synthetic attributes comprise an attribute that differs relative to existing attributes of the file. The synthetic attribute of the file may be generated by comparing current attributes of the file with previous attributes of the file. For instance, an exemplary event may include a renaming of file 120 from “ABC” to “XYZ.” The synthetic attribute of file 120 may the previous name of file 120, “ABC”, which differs from the actual name of file 120, “XYZ.” In another example, the event may be a move of file 121 from local device storage location 130 to online file hosting service 131. In this example, the synthetic attribute of file 121 may be the previous location of the file (i.e., local device storage location 130) and the actual attribute may be the current location of the file (i.e., online file hosting service 131). In yet another example, the event may be a nicknaming of the file in file aggregation service 101 which differs from the existing name of the file.

Having generated the synthetic attributes of the file based at least on the one or more events, the program instructions direct the computing system(s) to generate a file system view of the set of files (step 204). The file system view comprises the one or more synthetic attributes of the file. For example, if the user is viewing a complete list of the files, then file 120 having the previous name “ABC” would be displayed with the title of “ABC.” In this example, the current name may be displayed in addition to the previous name The program instructions then direct the computing system(s) to display the file system view of the set of files (step 205). Displaying the file system view of the set of files may further include displaying a toggle button to the user to toggle between viewing the file with the synthetic attribute only or with the actual attribute in addition to, or in place of, the synthetic attribute.

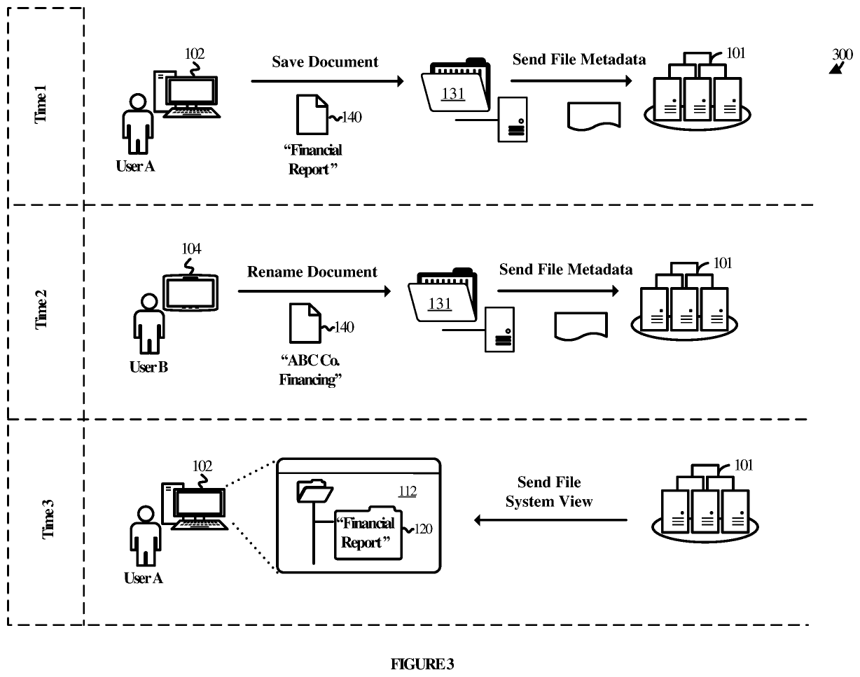

FIG. 3 illustrates an operational sequence in an implementation of an enhanced file aggregation service. In a first operation, document 140 is identified by file aggregation service 101 as being associated with user A. User A is interacting with document 140 in user environment 102. Document 140 is identified as being saved as “Financial Report” in file hosting service 131. File hosting service 131 then transfers metadata to file aggregation service 101. The metadata in this example scenario is associated with the file name, the file location, and the saving event that occurred with respect to document 140. File hosting service 101 then stores the metadata associated with document 140.

In a next operation, at time two, user B interacts with document 140 in user environment 104. In particular, user B renames document 140 from the title “Financial Report” to “ABC Co. Financing” in file hosting service 131. In response to the updated information, file hosting service transfers additional metadata to file aggregation service 101 indicating the rename event, in addition to the new name of document 140. File aggregation service 101 then saves the updated metadata associated with document 140.

In a final operation, at time three, user A requests file aggregation service 101 to display an aggregated view of the files associated with user A. In response, file aggregation service 101 generates synthetic attributes for at least document 140 of the set of files. In this example scenario, the synthetic attribute comprises the previous name of document 140 (i.e., “Financing Report”), which differs from the current name of document 140 (i.e., “ABC Co. Financing,”) as renamed by user B. File aggregation service 101 then displays file system view 112 to user A. File system view 112 includes a visual representation of document 140 using previous name 120 of document 140.

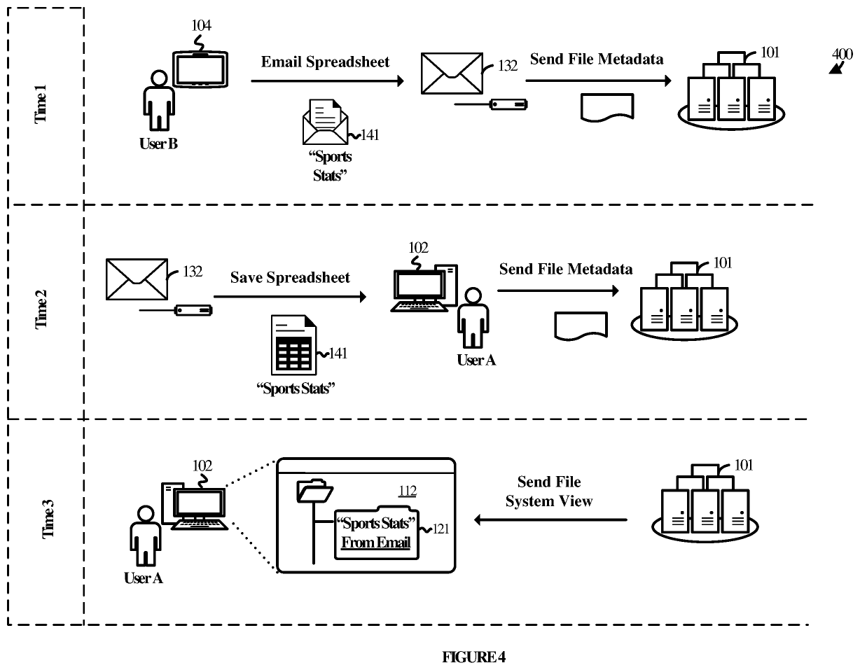

FIG. 4 illustrates an alternative operational sequence in an implementation of an enhanced file aggregation service. In a first operation, spreadsheet 141 is identified by file aggregation service 101 when user B emails spreadsheet 141 to user A in email service 132. User B is interacting with spreadsheet 141 in user environment 104. Email service 132 then transfers metadata to file aggregation service 101. The metadata in this example scenario is associated with the file name (i.e., “Sports Stats”), the file location (i.e., email service 132), and the emailing event that occurred with respect to spreadsheet 141. File hosting service 101 then stores the metadata associated with spreadsheet 141.

In a next operation, at time two, user A interacts with spreadsheet 141 in user environment 102. In particular, user A saves spreadsheet 141 from email service 132 to local storage in user environment 102. In response to the updated information, user environment 102 transfers additional metadata to file aggregation service 101 indicating the save event, in addition to the previous email event of spreadsheet 141. File aggregation service 101 then saves the updated metadata associated with spreadsheet 141.

In a final operation, at time three, user A requests file aggregation service 101 to display an aggregated view of the files associated with user A. In response, file aggregation service 101 generates synthetic attributes for at least spreadsheet 141 of the set of files. In this example scenario, the synthetic attribute comprises the originating location of spreadsheet 141 to user A (i.e., via email service 132), which differs from the current location of spreadsheet 141 (i.e., local storage in user environment 102). File aggregation service 101 then displays file system view 112 to user A. File system view 112 includes a visual representation of spreadsheet 141 using originating location 121 of spreadsheet 141.

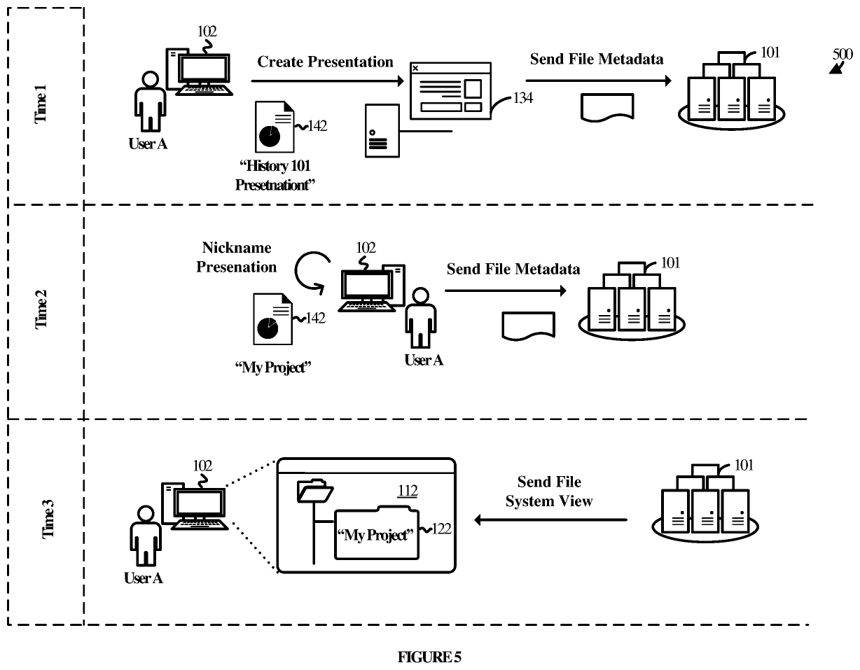

FIG. 5 illustrates an alternative operational sequence in an implementation of an enhanced file aggregation service. In a first operation, presentation 142 is identified by file aggregation service 101 as being associated with user A. User A is interacting with presentation 142 in user environment 102. Email service 132 then transfers metadata to file aggregation service 101. The metadata in this example scenario is associated with the file name (i.e., “Sports Stats”), the file location (i.e., email service 132), and the emailing event that occurred with respect to spreadsheet 141. File hosting service 101 then stores the metadata associated with spreadsheet 141.

In a next operation, at time two, user A interacts with spreadsheet 141 in user environment 102. In particular, user A saves spreadsheet 141 from email service 132 to local storage in user environment 102. In response to the updated information, user environment 102 transfers additional metadata to file aggregation service 101 indicating the save event, in addition to the previous email event of spreadsheet 141. File aggregation service 101 then saves the updated metadata associated with spreadsheet 141.

In a final operation, at time three, user A requests file aggregation service 101 to display an aggregated view of the files associated with user A. In response, file aggregation service 101 generates synthetic attributes for at least spreadsheet 141 of the set of files. In this example scenario, the synthetic attribute comprises the originating location of spreadsheet 141 to user A (i.e., via email service 132), which differs from the current location of spreadsheet 141 (i.e., local storage in user environment 102). File aggregation service 101 then displays file system view 112 to user A. File system view 112 includes a visual representation of spreadsheet 141 using originating location 121 of spreadsheet 141.

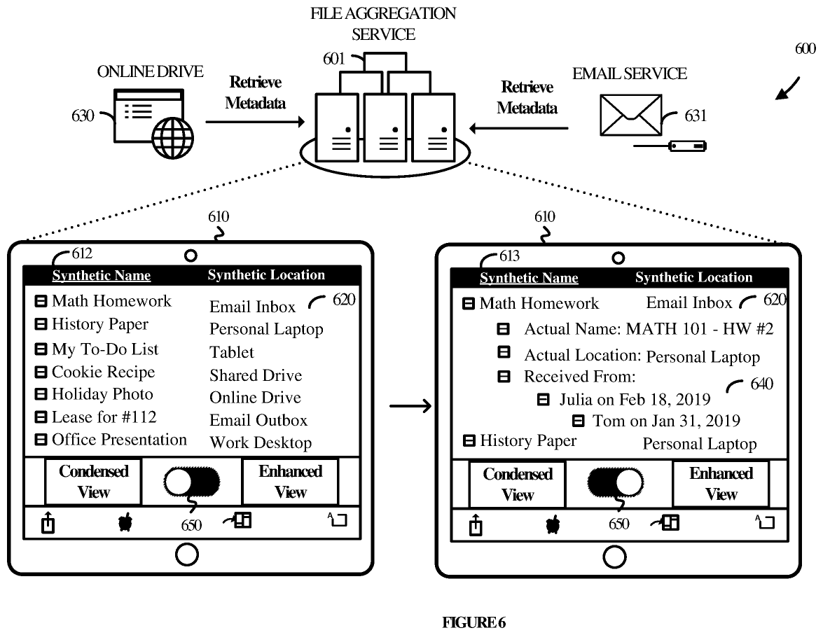

FIG. 6 illustrates a user experience in an implementation of an enhanced file aggregation service. User experience 600 in another example of file attribute synthesizing process 200 with respect to the elements of operational environment 100. User experience 600 includes user interface 610 to file aggregation service 601. File aggregation service 601 receives file metadata from various storage locations, such as online service 630 and email service 631. File aggregation service 601 generates synthesized attributes associated with the user's files. File aggregation service 601 then generates file system view 612. File system view 612 is displayed by user interface 610.

File system view 612 includes various file representations associated with the user. The file representations include a synthesized name and location. It should be noted that only one synthetized attribute need be displayed. For example, first file representation 620 may be displayed using only the synthetized name of “Math Homework,” without the synthetized location concurrently displayed.

File aggregation service 601 also generates expanded file system view 613. Expanded file system view 613 comprises existing attributes 640 of the file in addition to synthetic attributes 620 of the file. User interface 610 displayed toggle button 650 which allows the user to toggle between file system view 612 and expanded file system view 613. In response to a user selection, user interface 610 displays expanded file system view 613.

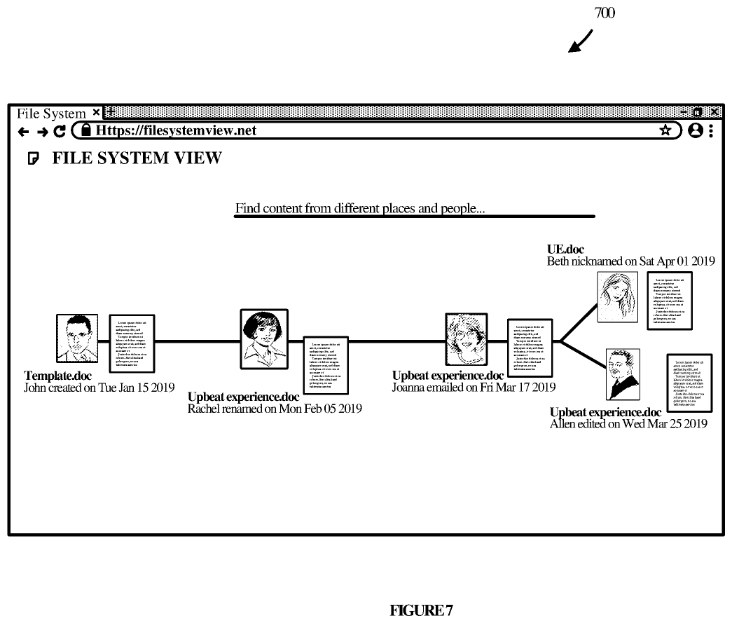

FIG. 7 illustrates a user interface in accordance with enhanced file aggregation service. In user experience 700 in FIG. 7, the users are able to view the journey of a document. The document journey may be generated by a file aggregation system to display which events have occurred with respect to the file, which users have interacted with the file, and in what sequence.

For example, a document template was initially created by Jon. The template may have been stored to a shared storage location. Next, Rachel accesses the document template and renames the document with a new name, such as “Upbeat experience.” Once again, the document is stored in a shared storage location. At a later time, Joanna emails the renamed document to Beth and Allen. Referring to the top branch of the file journey, Beth nicknames the document in her file system view to read “UE.” On the branch of the file journey, Allen edits the emailed document and stores a copy to his local device.

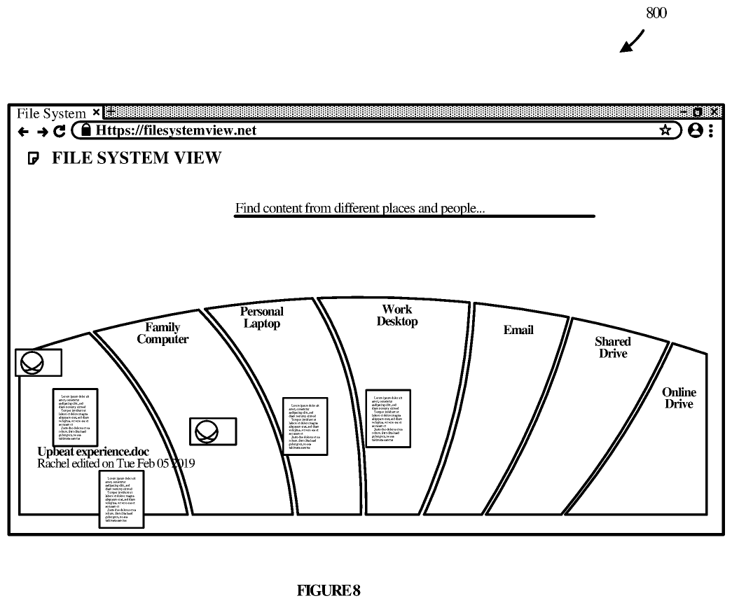

FIG. 8 illustrates an alternative user interface in accordance with enhanced file aggregation service. In user experience 800 in FIG. 8, the users are able to view an alternative aggregate file system view. While previous file system views described above have displayed the file system views as a list of documents, user experience 800 allows a user to view files stored in various storage locations in a more cohesive manner

For example, the file system view may show all of the storage locations that Rachel has subscribed to. In this example, each to the storage locations may then be populated with representations of files stored within each storage location. In other scenarios, the user may be able to expand the file system view to see additional information related to the file, such as existing file attributes which are not displayed in the condensed file system view.

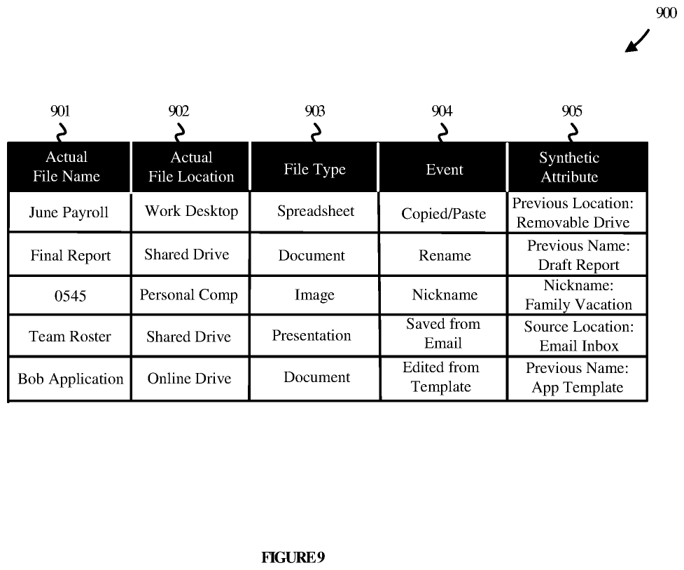

FIG. 9 illustrates a data structure in an implementation of an enhanced file aggregation service. Data structure 900 is representative of the metadata stored for each of the files in a set of files associated with a user. Column 901 includes the actual file name, such as “June Payroll.” In a next column, column 902 include the actual location in which the file is currently stored. For example, the file may be stored on the desktop of a user's workplace computer. Data structure 900 also stores a file type in column 903, such as a spreadsheet, text document, image, presentation, etc. In column 904, data structure 900 includes a list of event associated with each of the files in the set of files associated with the user. For example, the file may have been copied and pasted from another location, the file may have been renamed, the file may also have been internally nicknamed for the user's convenience, the file may have been saved from an email, the file may have been edited from a template, etc. In a final column, data structure 900 maintains at least one synthetic attribute of the file. For example, the synthetic attribute may be a previous location, a previous name, a nickname, a source location, a source template, etc.

FIG. 10 illustrates a computing system 1001 that is representative of any system or collection of systems in which the various processes, programs, services, and scenarios disclosed herein may be implemented. Examples of computing system 1001 include, but are not limited to, desktop computers, laptop computers, server computers, routers, web servers, cloud computing platforms, and data center equipment, as well as any other type of physical or virtual server machine, physical or virtual router, container, and any variation or combination thereof.

Computing system 1001 may be implemented as a single apparatus, system, or device or may be implemented in a distributed manner as multiple apparatuses, systems, or devices. Computing system 1001 includes, but is not limited to, processing system 1002, storage system 1003, software 1005, communication interface system 1007, and user interface system 1009 (optional). Processing system 1002 is operatively coupled with storage system 1003, communication interface system 1007, and user interface system 1009.

Processing system 1002 loads and executes software 1005 from storage system 1003. Software 1005 includes and implements process 1006, which is representative of the file attribute synthesizing technology discussed with respect to the preceding Figures. When executed by processing system 1002 to provide synthesized attributes for files, software 1005 directs processing system 1002 to operate as described herein for at least the various processes, operational scenarios, and sequences discussed in the foregoing implementations. Computing system 1001 may optionally include additional devices, features, or functionality not discussed for purposes of brevity.

Referring still to FIG. 10, processing system 1002 may comprise a micro-processor and other circuitry that retrieves and executes software 1005 from storage system 1003. Processing system 1002 may be implemented within a single processing device but may also be distributed across multiple processing devices or sub-systems that cooperate in executing program instructions. Examples of processing system 1002 include general purpose central processing units, graphical processing units, application specific processors, and logic devices, as well as any other type of processing device, combinations, or variations thereof.

Storage system 1003 may comprise any computer readable storage media readable by processing system 1002 and capable of storing software 1005. Storage system 1003 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1003 may also include computer readable communication media over which at least some of software 1005 may be communicated internally or externally. Storage system 1003 may be implemented as a single storage device but may also be implemented across multiple storage devices or sub-systems co-located or distributed relative to each other. Storage system 1003 may comprise additional elements, such as a controller, capable of communicating with processing system 1002 or possibly other systems.

Software 1005 (including process 1006) may be implemented in program instructions and among other functions may, when executed by processing system 1002, direct processing system 1002 to operate as described with respect to the various operational scenarios, sequences, and processes illustrated herein. For example, software 1005 may include program instructions for implementing file attribute synthesizing as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1005 may include additional processes, programs, or components, such as operating system software, virtualization software, or other application software. Software 1005 may also comprise firmware or some other form of machine-readable processing instructions executable by processing system 1002.

In general, software 1005 may, when loaded into processing system 1002 and executed, transform a suitable apparatus, system, or device (of which computing system 1001 is representative) overall from a general-purpose computing system into a special-purpose computing system customized to provide file attribute synthesizing as described herein. Indeed, encoding software 1005 on storage system 1003 may transform the physical structure of storage system 1003. The specific transformation of the physical structure may depend on various factors in different implementations of this description. Examples of such factors may include, but are not limited to, the technology used to implement the storage media of storage system 1003 and whether the computer-storage media are characterized as primary or secondary storage, as well as other factors.

For example, if the computer readable storage media are implemented as semiconductor-based memory, software 1005 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1007 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1001 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Example 1. A method of operating a file aggregation service, the method comprising: identifying a set of files associated with a user; for at least a file of the set of files: identifying one or more events that occurred with respect to the file; generating one or more synthetic attributes of the file based at least on the one or more events, wherein the one or more synthetic attributes comprise an attribute that differs relative to existing attributes of the file; generating a file system view of the set of files, wherein the file system view comprises the one or more synthetic attributes of the file; and displaying the file system view of the set of files.

Example 2. The method of Example 1 wherein: the one or more synthetic attributes of the file comprise one or more synthetic names of the file; and the file system view of the set of files is displayed using at least the one or more synthetic names of the file of the set files.

Example 3. The method of Examples 1-2 wherein: the one or more synthetic attributes of the file comprise one or more identifications of file hosting services associated with the file; and the file system view of the set of files is displayed using at least the one or more identifications of file hosting services associated with the file.

Example 4. The method of Examples 1-3 wherein: identifying the one or more events that occurred with respect to the file comprises determining that the file has been renamed in a location in which the file is stored; generating the file system view of the set of files comprises generating the file system view of the set of files using at least a previous name of the file, wherein the previous name differs from the current name of the file; and displaying the file system view of the set of files using at least the previous name of the file.

Example 5. The method of Examples 1-4 wherein: identifying the one or more events that occurred with respect to the file comprises receiving user input indicating an alias of the file; generating the file system view of the set of files comprises generating the file system view of the set of files using at least the alias of the file, wherein the alias differs from the actual name of the file; and displaying the file system view of the set of files using at least the alias of the file.

Example 6. The method of Examples 1-5 wherein: identifying the one or more events that occurred with respect to the file comprises determining that the file has been moved from a source location of the file to a destination location of the file; generating the file system view of the set of files comprises generating the file system view of the set of files using at least the source location of the file, wherein the source location of the file differs from the destination location of the file; and displaying the file system view of the set of files using at least the source location of the file.

Example 7. The method of Examples 1-6 wherein: identifying the one or more events that occurred with respect to the file comprises determining that the file has been saved from an email service to file hosting service; generating the file system view of the set of files comprises generating the file system view of the set of files using at the least the email service from which the file was originally received; and displaying the file system view of the set of files using at least the email service from which the file was originally received.

Example 8. The method of Examples 1-7 wherein further comprising: generating an expanded file system view of at least the file of the set of files, wherein the expanded view of the file comprises the existing attributes of the file in addition to the synthetic attributes of the file; displaying a toggle button which allows the user to toggle between the file system view and the expanded file system view; and in response to a user selection, displaying the expanded file system view of the file.

Example 9. The method of Examples 1-8 wherein the one or more events are identified by receiving a notification of the one or more events from at least one of a file hosting service, a user application, and a local storage system.

Example 10. A computing apparatus comprising: one or more computer readable storage media; one or more processors operatively coupled with the one or more computer readable storage media; and program instructions stored on the one or more computer readable storage media that, when read and executed by the one or more processors, direct the one or more processors to at least: identify a set of files associated with a user; for at least a file of the set of files: identify one or more events that occurred with respect to the file; generate one or more synthetic attributes of the file based at least on the one or more events, wherein the one or more synthetic attributes comprise an attribute that differs relative to existing attributes of the file; generate a file system view of the set of files, wherein the file system view comprises the one or more synthetic attributes of the file; and display the file system view of the set of files to a user.

Example 11. The computing apparatus of Example 10 wherein: the one or more synthetic attributes of the file comprise one or more synthetic names of the file; and the file system view of the set of files is displayed using at least the one or more synthetic names of the file of the set files.

Example 12. The computing apparatus of Examples 10-11 wherein: the one or more synthetic attributes of the file comprise one or more identifications of file hosting services associated with the file; and the file system view of the set of files is displayed using at least the one or more identifications of file hosting services associated with the file.

Example 13. The computing apparatus of Examples 10-12 wherein to identify the one or more events that occurred with respect to the file and generate the file system view of the set of files, the program instructions direct the one or more processors to: determine that the file has been renamed in a location in which the file is stored; and generate the file system view of the set of files using at least a previous name of the file, wherein the previous name differs from the current name of the file.

Example 14. The computing apparatus of Examples 10-13 wherein to identify the one or more events that occurred with respect to the file and generate the file system view of the set of files, the program instructions direct the one or more processors to: receive user input indicating an alias of the file; and generate the file system view of the set of files using at least the alias of the file, wherein the alias differs from the actual name of the file.

Example 15. The computing apparatus of Examples 10-14 wherein to identify the one or more events that occurred with respect to the file and generate the file system view of the set of files, the program instructions direct the one or more processors to: determine that the file has been moved from a source location of the file to a destination location of the file; and generate the file system view of the set of files using at least the source location of the file, wherein the source location of the file differs from the destination location of the file.

Example 16. The computing apparatus of Examples 10-15 wherein to identify the one or more events that occurred with respect to the file and generate the file system view of the set of files, the program instructions direct the one or more processors to: determine that the file has been saved from an email service to file hosting service; and generate the file system view of the set of files using at the least the email service from which the file was originally received.

Example 17. The computing apparatus of Examples 10-16 wherein the processing instructions are further configured to direct the one or more processors to: generate an expanded file system view of at least the file of the set of files, wherein the expanded view of the file comprises the existing attributes of the file in addition to the synthetic attributes of the file; display a toggle button which allows the user to toggle between the file system view and the expanded file system view; and in response to a user selection, display the expanded file system view of the file.

Example 18. The computing apparatus of Examples 10-17 wherein the one or more events are identified by receiving a notification of the one or more events from at least one of a file hosting service, a user application, and a local storage system.

Example 19. A computing apparatus comprising: one or more computer readable storage media; one or more processors operatively coupled with the one or more storage media; and an application comprising program instructions stored on the one or more computer readable storage media that, when executed by the one or more processors, direct the computing apparatus to at least: for at least a file of the set of files: identify one or more events that occurred with respect to the file; generate one or more synthetic attributes of the file based at least on the one or more events, wherein the one or more synthetic attributes comprise an attribute that differs relative to existing attributes of the file; generate a file system view of the set of files, wherein the file system view comprises the one or more synthetic attributes of the file; generate an expanded file system view of at least the file of the set of files, wherein the expanded view of the file comprises the existing attributes of the file in addition to the synthetic attributes of the file; and in response to a user selection, toggle between displaying the file system view and displaying the expanded file system view in the user interface to the user.

Example 20. The computing apparatus of Example 19 wherein: the one or more synthetic attributes of the file comprise one or more of a synthetic name of the file and an identification of a file hosting service associated with the file; and the file system view of the set of files is displayed using at least the one or more of the synthetic name of the file and an identification of a file hosting service associated with the file of the set of files.

What is claimed is:

1. A method of operating a file aggregation service, the method comprising:
identifying a set of files associated with a user;
for at least a file of the set of files:
identifying one or more events that occurred with respect to the file;
generating one or more synthetic attributes of the file based at least on the one or more events, wherein the one or more synthetic attributes comprise an attribute that differs relative to existing attributes of the file;
generating a file system view of the set of files, wherein the file system view comprises the one or more synthetic attributes of the file; and
displaying the file system view of the set of files.

2. The method of claim 1 wherein:
the one or more synthetic attributes of the file comprise one or more synthetic names of the file; and
the file system view of the set of files is displayed using at least the one or more synthetic names of the file of the set files.

3. The method of claim 1 wherein:
the one or more synthetic attributes of the file comprise one or more identifications of file hosting services associated with the file; and
the file system view of the set of files is displayed using at least the one or more identifications of file hosting services associated with the file.

4. The method of claim 1 wherein:
identifying the one or more events that occurred with respect to the file comprises determining that the file has been renamed in a location in which the file is stored;
generating the file system view of the set of files comprises generating the file system view of the set of files using at least a previous name of the file, wherein the previous name differs from the current name of the file; and
displaying the file system view of the set of files using at least the previous name of the file.

5. The method of claim 1 wherein:
identifying the one or more events that occurred with respect to the file comprises receiving user input indicating an alias of the file;
generating the file system view of the set of files comprises generating the file system view of the set of files using at least the alias of the file, wherein the alias differs from the actual name of the file; and
displaying the file system view of the set of files using at least the alias of the file.

6. The method of claim 1 wherein:
identifying the one or more events that occurred with respect to the file comprises determining that the file has been moved from a source location of the file to a destination location of the file;
generating the file system view of the set of files comprises generating the file system view of the set of files using at least the source location of the file, wherein the source location of the file differs from the destination location of the file; and
displaying the file system view of the set of files using at least the source location of the file.

7. The method of claim 1 wherein:
identifying the one or more events that occurred with respect to the file comprises determining that the file has been saved from an email service to file hosting service;
generating the file system view of the set of files comprises generating the file system view of the set of files using at the least the email service from which the file was originally received; and
displaying the file system view of the set of files using at least the email service from which the file was originally received.

8. The method of claim 1 wherein further comprising:
generating an expanded file system view of at least the file of the set of files, wherein the expanded file system view of the file comprises the existing attributes of the file in addition to the synthetic attributes of the file;
displaying a toggle button which allows the user to toggle between the file system view and the expanded file system view; and
in response to a user selection, displaying the expanded file system view of the file.

9. The method of claim 1 wherein the one or more events are identified by receiving a notification of the one or more events from at least one of a file hosting service, a user application, and a local storage system.

10. A computing apparatus comprising:
one or more computer readable storage media;
one or more processors operatively coupled with the one or more computer readable storage media; and
program instructions stored on the one or more computer readable storage media that, when read and executed by the one or more processors, direct the one or more processors to at least:
identify a set of files associated with a user;
for at least a file of the set of files:
identify one or more events that occurred with respect to the file;
generate one or more synthetic attributes of the file based at least on the one or more events, wherein the one or more synthetic attributes comprise an attribute that differs relative to existing attributes of the file;
generate a file system view of the set of files, wherein the file system view comprises the one or more synthetic attributes of the file; and
display the file system view of the set of files to a user.

11. The computing apparatus of claim 10 wherein:
the one or more synthetic attributes of the file comprise one or more synthetic names of the file; and
the file system view of the set of files is displayed using at least the one or more synthetic names of the file of the set files.

12. The computing apparatus of claim 10 wherein:
the one or more synthetic attributes of the file comprise one or more identifications of file hosting services associated with the file; and
the file system view of the set of files is displayed using at least the one or more identifications of file hosting services associated with the file.

13. The computing apparatus of claim 10 wherein to identify the one or more events that occurred with respect to the file and generate the file system view of the set of files, the program instructions direct the one or more processors to:
determine that the file has been renamed in a location in which the file is stored; and
generate the file system view of the set of files using at least a previous name of the file, wherein the previous name differs from the current name of the file.

14. The computing apparatus of claim 10 wherein to identify the one or more events that occurred with respect to the file and generate the file system view of the set of files, the program instructions direct the one or more processors to:
receive user input indicating an alias of the file; and
generate the file system view of the set of files using at least the alias of the file, wherein the alias differs from the actual name of the file.

15. The computing apparatus of claim 10 wherein to identify the one or more events that occurred with respect to the file and generate the file system view of the set of files, the program instructions direct the one or more processors to:
determine that the file has been moved from a source location of the file to a destination location of the file; and
generate the file system view of the set of files using at least the source location of the file, wherein the source location of the file differs from the destination location of the file.

16. The computing apparatus of claim 10 wherein to identify the one or more events that occurred with respect to the file and generate the file system view of the set of files, the program instructions direct the one or more processors to:
determine that the file has been saved from an email service to file hosting service; and
generate the file system view of the set of files using at the least the email service from which the file was originally received.

17. The computing apparatus of claim 10 wherein the processing instructions are further configured to direct the one or more processors to:
generate an expanded file system view of at least the file of the set of files, wherein the expanded file system view of the file comprises the existing attributes of the file in addition to the synthetic attributes of the file;
display a toggle button which allows the user to toggle between the file system view and the expanded file system view; and
in response to a user selection, display the expanded file system view of the file.

18. The computing apparatus of claim 10 wherein the one or more events are identified by receiving a notification of the one or more events from at least one of a file hosting service, a user application, and a local storage system.

19. A computing apparatus comprising:
one or more computer readable storage media;
one or more processors operatively coupled with the one or more storage media; and
an application comprising program instructions stored on the one or more computer readable storage media that, when executed by the one or more processors, direct the computing apparatus to at least:
for at least a file of the set of files:
identify one or more events that occurred with respect to the file;
generate one or more synthetic attributes of the file based at least on the one or more events, wherein the one or more synthetic attributes comprise an attribute that differs relative to existing attributes of the file;
generate a file system view of the set of files, wherein the file system view comprises the one or more synthetic attributes of the file;
generate an expanded file system view of at least the file of the set of files, wherein the expanded file system view of the file comprises the existing attributes of the file in addition to the synthetic attributes of the file; and
in response to a user selection, toggle between displaying the file system view and displaying the expanded file system view in the user interface to the user.

20. The computing apparatus of claim 19 wherein:
the one or more synthetic attributes of the file comprise one or more of a synthetic name of the file and an identification of a file hosting service associated with the file; and
the file system view of the set of files is displayed using at least the one or more of the synthetic name of the file and an identification of a file hosting service associated with the file of the set of files.
